(19) United States
(12) Patent Application Publication
(10) Pub. No.: US 2004/0205326 A1
(43) Pub. Date: Oct. 14, 2004

(54) Early predicate evaluation to reduce power in very long instruction word processors employing predicate execution

(76) Inventors: Vijay K.G. Sindagi, Bangalore (IN); Mahesh Mehendale, Bangalore (IN)

Correspondence Address: TEXAS INSTRUMENTS INCORPORATED, P O BOX 655474, M/S 3999, DALLAS, TX, 75265

(21) Appl. No.: 10/799,375

(22) Filed: Mar. 12, 2004

Related U.S. Application Data
(60) Provisional application No. 60/454,169, filed on Mar. 12, 2003.

(51) Int. Cl. G06F 9/30

(52) U.S. Cl. 712/226; 712/217

(57) ABSTRACT

This invention reduces redundant power consumption by early detection of predicate register values. This detects pending writes to the predicate registers. When there are no pending predicate register updates, the predicate value is read in the decode stage and a decision whether to nullify the instruction is made. When a write is pending, the instruction executes normally and the result write-back only is dependent upon the newly written predicate value. In the former case, nullifying an instruction completion saves power. The compiler attempts to increase the distance between the predicate-definition and predicate-use by the number of cycles required by the architecture. This scheduling increases the conditions under which the early predicate detection is possible and hence enhances the possibility of power saving.

### CLAIM OF PRIORITY

This application claims priority under 35 U.S.C. §119(e) (1) from U.S. Provisional Application No. 60/454,169 filed Mar. 12, 2003.

### TECHNICAL FIELD OF THE INVENTION

The technical field of this invention is power reduction in very long instruction word processors.

### BACKGROUND OF THE INVENTION

Very long instruction word (VLIW) or explicitly parallel instruction computer (EPIC) processors employ predicated execution to boost performance. Many VLIW/EPIC processors execute instructions under predication. The predicated instruction is executed without regard to whether the computation is useful. If an instruction is dependent on the result of a previous instruction and that result is not yet available, the processor typically stalls until the result is available. In more sophisticated processors, the dependent instruction is executed without waiting for resolution of the gating condition. However the result of the computation is committed if and only if the gating condition is true. This process is called predicated or speculative execution.

Predication allows higher performance and greater flexibility in instruction scheduling. Predication allows higher performance by overcoming control and data dependency hazards. Many compiler techniques overcome branch ill-effects by converting control dependency into data dependency. This technique is called if-conversion. If-conversion enables instructions from multiple basic blocks to be executed in the same execution packet. Speculation helps in moving instructions ahead of where their results are required.

While predicated execution provides increased performance, it has the downside. Predicated execution causes execution of many instructions whose results are not useful. This leads to wasted energy in the processor. This wasted energy in turn leads to unneeded power consumption and production of excess heat.

Predicated execution may be both dynamically scheduled by the hardware and statically scheduled by the compiler. The Texas Instruments TMS320C6000 architecture is an example of a VLIW processor which supports speculative execution of instructions through a predication mechanism. All instructions of this instruction architecture are predicated. In a predicated instruction the instruction execution occurs but the result is committed based on the value of a predicate or condition register specified in the instruction. All instructions must be decoded regardless of their final effect. Each instruction must proceed through the pipeline to a stage which generally includes reading their register operands. Such operations waste energy for predicated instructions that are not committed.

Thus VLIW processors employing aggressive scheduling techniques execute redundant instructions contributing to increased power consumption. In typical digital signal processor applications 6% to 12% of instructions executed go to waste because their results are never committed. It is beneficial to save the power consumed in these wasted instructions.

### SUMMARY OF THE INVENTION

This invention is a mechanism to reduce this redundant power consumption by early detection of predicate register values. Detecting the TRUE/FALSE value of the predicate register early in the decode stage enables the possibility to nullify that instruction if the predicate value is FALSE. This saves the power otherwise consumed in decode, register read and execute stages of the pipeline.

A minor complication is that the predicate register may be updated by instructions currently in the execute stage. This new value of the predicate register would be available a cycle later. Hence it would not be possible to always nullify predicated instructions in the decode stage. This invention employs scoreboard bits for the predicate registers. These scoreboard bits signal pending writes to the predicate registers. When there are no pending predicate register updates, the predicate value can be read early in the decode stage and a decision whether to nullify the instruction can be made. When a write is pending to the predicate register, the instruction is allowed to execute normally, with the result write-back happening only at a later stage in execution dependent upon the newly written predicate value. In the latter case power expended in these speculatively executed instructions can not be saved. In the former case, nullifying an instruction completion saves power.

The compiler can be made aware of this hardware implementation to save more power by appropriate instruction scheduling. The compiler increases the distance between the predicate-definition and predicate-use by the number of cycles required by the architecture. In the case of the Texas Instruments TMS320C6000 this length is two pipeline stages. This is the distance from the predicate register update in an execute stage to predicate register read in a decode stage. Such scheduling will increase the conditions under which the early predicate detection is possible and hence enhance the possibility of power saving.

### BRIEF DESCRIPTION OF THE DRAWINGS

These and other aspects of this invention are illustrated in the drawings, in which:

FIG. 1 illustrates the organization of a typical digital signal processor to which this invention is applicable;

FIG. 2 illustrates details of a very long instruction word digital signal processor core suitable for use in FIG. 1;

FIG. 3 illustrates the pipeline stages of the very long instruction word digital signal processor core illustrated in FIG. 2;

FIG. 4 illustrates the instruction syntax of the very long instruction word digital signal processor core illustrated in FIG. 2;

FIG. 5 schematically illustrates the scoreboard hardware for each data register that can serve as a predicate register;

FIG. 6 schematically illustrates the hardware for the early and regular conditional execution (predication);

### DETAILED DESCRIPTION OF PREFERRED EMBODIMENTS

A preferred embodiment of this invention will be described in this section. This invention is not limited to the preferred embodiment. It would be a straight forward task for one skilled in the art to apply the invention to a larger class of data processing architectures that employ statically scheduled execution with predication mechanism.

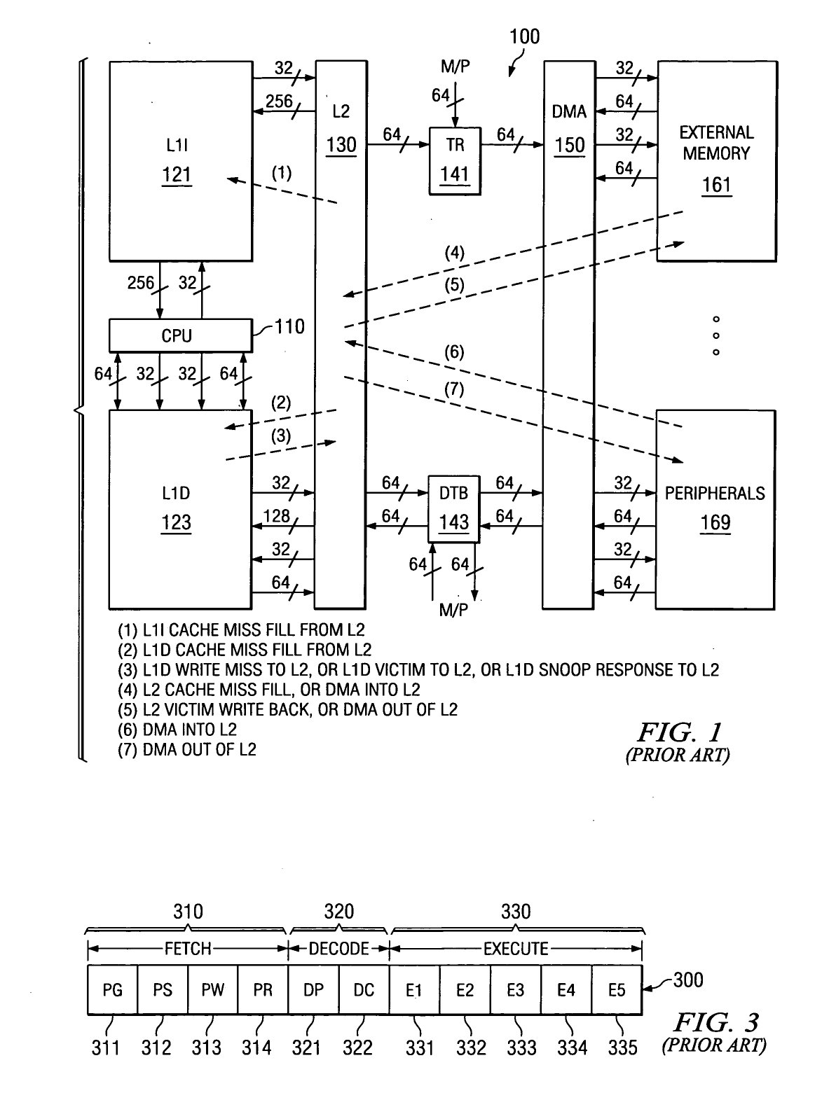

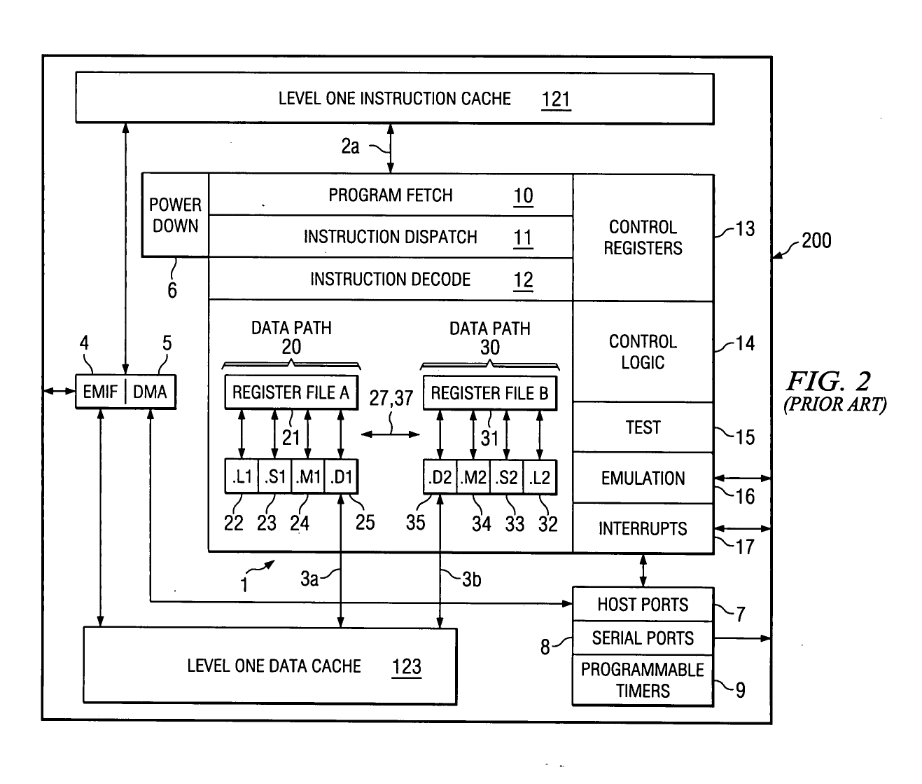

FIG. 1 illustrates the organization of a typical digital signal processor system 100 to which this invention is applicable. Digital signal processor system 100 includes central processing unit core 110. Central processing unit core 110 includes the data processing portion of digital signal processor system 100. Central processing unit core 110 could be constructed as known in the art and would typically includes a register file, an integer arithmetic logic unit, an integer multiplier and program flow control units. An example of an appropriate central processing unit core is described below in conjunction with FIGS. 2 to 4.

Digital signal processor system 100 includes a number of cache memories. FIG. 1 illustrates a pair of first level caches. Level one instruction cache (L1I) 121 stores instructions used by central processing unit core 110. Central processing unit core 110 first attempts to access any instruction from level one instruction cache 121. Level one data cache (L1D) 123 stores data used by central processing unit core 110. Central processing unit core 110 first attempts to access any required data from level one data cache 123. The two level one caches are backed by a level two unified cache (L2) 130. In the event of a cache miss to level one instruction cache 121 or to level one data cache 123, the requested instruction or data is sought from level two unified cache 130. If the requested instruction or data is stored in level two unified cache 130, then it is supplied to the requesting level one cache for supply to central processing unit core 110. As is known in the art, the requested instruction or data may be simultaneously supplied to both the requesting cache and central processing unit core 110 to speed use.

Level two unified cache 130 is further coupled to higher level memory systems. Digital signal processor system 100 may be a part of a multiprocessor system. The other processors of the multiprocessor system are coupled to level two unified cache 130 via a transfer request bus 141 and a data transfer bus 143. A direct memory access unit 150 provides the connection of digital signal processor system 100 to external memory 161 and external peripherals 169.

FIG. 2 is a block diagram illustrating details of a digital signal processor integrated circuit 200 suitable but not essential for use in this invention. The digital signal processor integrated circuit 200 includes central processing unit 1, which is a 32-bit eight-way VLIW pipelined processor. Central processing unit 1 is coupled to level 1 instruction cache 121 included in digital signal processor integrated circuit 200. Digital signal processor integrated circuit 200 also includes level one data cache 123. Digital signal processor integrated circuit 200 also includes peripherals 4 to 9. These peripherals preferably include an external memory interface (EMIF) 4 and a direct memory access (DMA) controller 5. External memory interface (EMIF) 4 preferably supports access to supports synchronous and asynchronous SRAM and synchronous DRAM. Direct memory access (DMA) controller 5 preferably provides 2-channel auto-boot loading direct memory access. These peripherals include power-down logic 6. Power-down logic 6 preferably can halt central processing unit activity, peripheral activity, and phase lock loop (PLL) clock synchronization activity to reduce power consumption. These peripherals also include host ports 7, serial ports 8 and programmable timers 9.

Central processing unit 1 has a 32-bit, byte addressable address space. Internal memory on the same integrated circuit is preferably organized in a data space including level one data cache 123 and a program space including level one instruction cache 121. When off-chip memory is used, preferably these two spaces are unified into a single memory space via the external memory interface (EMIF) 4.

Level one data cache 123 may be internally accessed by central processing unit 1 via two internal ports 3a and 3b. Each internal port 3a and 3b preferably has 32 bits of data and a 32-bit byte address reach. Level one instruction cache 121 may be internally accessed by central processing unit 1 via a single port 2a. Port 2a of level one instruction cache 121 preferably has an instruction-fetch width of 256 bits and a 30-bit word (four bytes) address, equivalent to a 32-bit byte address.

Central processing unit 1 includes program fetch unit 10, instruction dispatch unit 11, instruction decode unit 12 and two data paths 20 and 30. First data path 20 includes four functional units designated L1 unit 22, S1 unit 23, M1 unit 24 and D1 unit 25 and 16 32-bit A registers forming register file 21. Second data path 30 likewise includes four functional units designated L2 unit 32, S2 unit 33, M2 unit 34 and D2 unit 35 and 16 32-bit B registers forming register file 31. The functional units of each data path access the corresponding register file for their operands. There are two cross paths 27 and 37 permitting access to one register in the opposite register file each pipeline stage. Central processing unit 1 includes control registers 13, control logic 14, and test logic 15, emulation logic 16 and interrupt logic 17.

Program fetch unit 10, instruction dispatch unit 11 and instruction decode unit 12 recall instructions from level one instruction cache 121 and deliver up to eight 32-bit instructions to the functional units every instruction cycle. Processing occurs in each of the two data paths 20 and 30. As previously described above each data path has four corresponding functional units (L, S, M and D) and a corresponding register file containing 16 32-bit registers. Each functional unit is controlled by a 32-bit instruction. The data paths are further described below. A control register file 13 provides the means to configure and control various processor operations.

FIG. 3 illustrates the pipeline stages 300 of digital signal processor core 110. These pipeline stages are divided into three groups: fetch group 310; decode group 320; and execute group 330. All instructions in the instruction set flow through the fetch, decode, and execute stages of the pipeline. Fetch group 310 has four phases for all instructions, and decode group 320 has two phases for all instructions. Execute group 330 requires a varying number of phases depending on the type of instruction.

The fetch phases of the fetch group 310 are: Program address generate phase 311 (PG); Program address send phase 312 (PS); Program access ready wait stage 313 (PW); and Program fetch packet receive stage 314 (PR). Digital signal processor core 110 uses a fetch packet (FP) of eight instructions. All eight of the instructions proceed through fetch group 310 together. During PG phase 311, the program address is generated in program fetch unit 10. During PS phase 312, this program address is sent to memory. During PW phase 313, the memory read occurs. Finally during PR phase 314, the fetch packet is received at CPU 1.

The decode phases of decode group 320 are: Instruction dispatch (DP) 321; and Instruction decode (DC) 322. During the DP phase 321, the fetch packets are split into execute packets. Execute packets consist of one or more instructions which are coded to execute in parallel. During DP phase 322, the instructions in an execute packet are assigned to the appropriate functional units. Also during DC phase 322, the source registers, destination registers and associated paths are decoded for the execution of the instructions in the respective functional units.

The execute phases of the execute group 330 are: Execute 1 (E2) 331; Execute 2 (E2) 332; Execute 3 (E3) 333; Execute 4 (E4) 334; and Execute 5 (E5) 335. Different types of instructions require different numbers of these phases to complete. These phases of the pipeline play an important role in understanding the device state at CPU cycle boundaries.

During E1 phase 331, the conditions for the instructions are evaluated and operands are read for all instruction types. For load and store instructions, address generation is performed and address modifications are written to a register file. For branch instructions, branch fetch packet in PG phase 311 is affected. For all single-cycle instructions, the results are written to a register file. All single-cycle instructions complete during the E1 phase 331.

During the E2 phase 332, for load instructions, the address is sent to memory. For store instructions, the address and data are sent to memory. Single-cycle instructions that saturate results set the SAT bit in the control status register (CSR) if saturation occurs. For single cycle 16×16 multiply instructions, the results are written to a register file. For M unit non-multiply instructions, the results are written to a register file. All ordinary multiply unit instructions complete during E2 phase 322.

During E3 phase 333, data memory accesses are performed. Any multiply instruction that saturates results sets the SAT bit in the control status register (CSR) if saturation occurs. Store instructions complete during the E3 phase 333.

During E4 phase 334, for load instructions, data is brought to the CPU boundary. For multiply extensions instructions, the results are written to a register file. Multiply extension instructions complete during the E4 phase 334.

During E5 phase 35, load instructions write data into a register. Load instructions complete during the E5 phase 335.

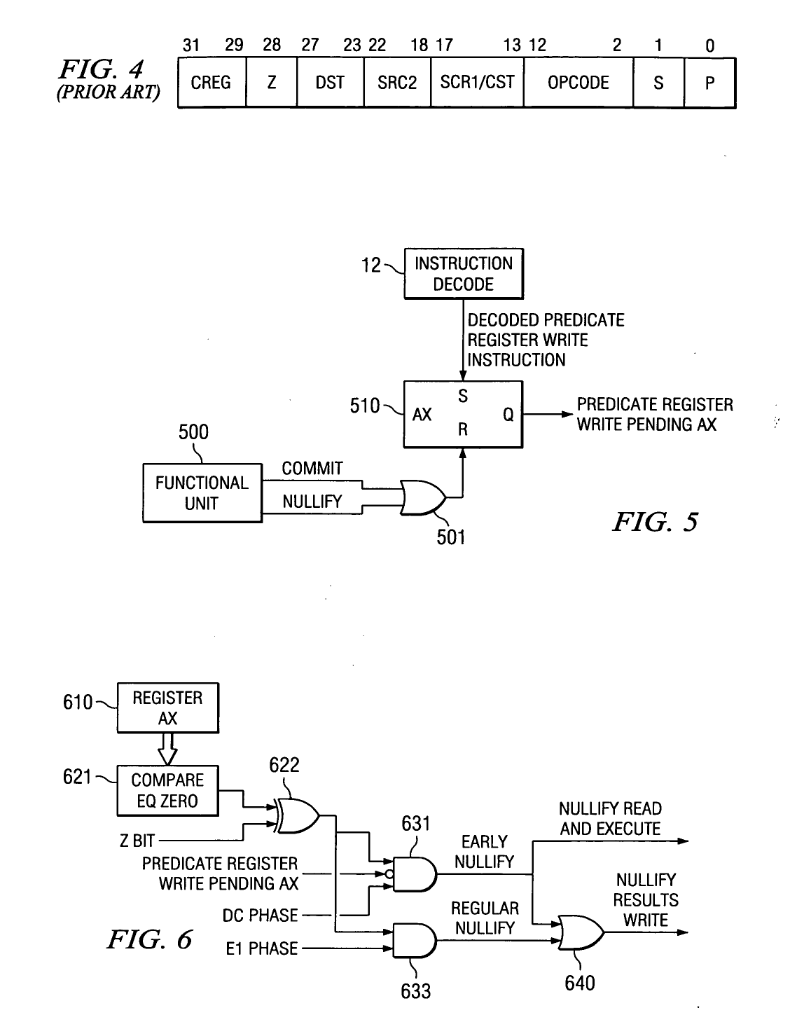

FIG. 4 illustrates an example of the instruction coding of instructions used by digital signal processor core 110. Each instruction consists of 32 bits and controls the operation of one of the eight functional units. The bit fields are defined as follows. The creg field (bits 29 to 31) is the conditional register field. These bits identify whether the instruction is conditional and identify the predicate register. The z bit (bit 28) indicates whether the predication is based upon zero or not zero in the predicate register. If z=1, the test is for equality with zero. If z=0, the test is for nonzero. The case of creg=0 and z=0 is treated as always true to allow unconditional instruction execution. The creg field is encoded in the instruction opcode as shown in Table 1.

TABLE 1

| Conditional | creg | | | z |
|---|---|---|---|---|
| Register | 31 | 30 | 29 | 28 |
| Unconditional | 0 | 0 | 0 | 0 |
| Reserved | 0 | 0 | 0 | 1 |
| B0 | 0 | 0 | 1 | z |
| B1 | 0 | 1 | 0 | z |
| B2 | 0 | 1 | 1 | z |
| A1 | 1 | 0 | 0 | z |
| A2 | 1 | 0 | 1 | z |
| A0 | 1 | 1 | 0 | z |
| Reserved | 1 | 1 | 1 | x |

Note that “z” in the z bit column refers to the zero/not zero comparison selection noted above and “x” is a don't care state. This coding can only specify a subset of the 32 registers in each register file as predicate registers. This selection was made to preserve bits in the instruction coding.

The dst field (bits 23 to 27) specifies one of the 32 registers in the corresponding register file as the destination of the instruction results.

The scr2 field (bits 18 to 22) specifies one of the 32 registers in the corresponding register file as the second source operand.

The scr1/cst field (bits 13 to 17) has several meanings depending on the instruction opcode field (bits 3 to 12). The first meaning specifies one of the 32 registers of the corresponding register file as the first operand. The second meaning is a 5-bit immediate constant. Depending on the instruction type, this is treated as an unsigned integer and zero extended to 32 bits or is treated as a signed integer and sign extended to 32 bits. Lastly, this field can specify one of the 32 registers in the opposite register file if the instruction invokes one of the register file cross paths 27 or 37.

The opcode field (bits 3 to 12) specifies the type of instruction and designates appropriate instruction options. A detailed explanation of this field is beyond the scope of this invention.

The s bit (bit 1) designates the data path 20 or 30. If s=0, then data path 20 is selected. This limits the functional unit to L1 unit 22, S1 unit 23, M1 unit 24 and D1 unit 25 and the corresponding register file A 21. Similarly, s=1 selects data path 20 limiting the functional unit to L2 unit 32, S2 unit 33, M2 unit 34 and D2 unit 35 and the corresponding register file B 31.

The p bit (bit 0) marks the execute packets. The p-bit determines whether the instruction executes in parallel with the following instruction. The p-bits are scanned from lower to higher address. If p=1 for the current instruction, then the next instruction executes in parallel with the current instruction. If p=0 for the current instruction, then the next instruction executes in the cycle after the current instruction. All instructions executing in parallel constitute an execute packet. An execute packet can contain up to eight instructions. Each instruction in an execute packet must use a different functional unit.

There have been no earlier attempts to save power in VLIW/EPIC architectures, other than the well known clock gating and similar design techniques. In the domain of dynamically scheduled super-scalar processors there have been attempts to reduce power in speculative execution. The paper “Pipeline Gating: Speculation control for energy reduction” by Srilatha et al presented at ISCA1998, Barcelona, Spain proposes a branch prediction confidence based pipeline gating mechanism. This technique is applicable to dynamically scheduled processors employing branch prediction hardware and with speculative execution capability. Their technique will likely reduce power at the cost of performance.

Similarly, M. Sami, D. Sciuto, C. Silvano, et al. in their paper titled “Exploiting data forwarding to reduce the power budget of VLIW embedded processors,” in Proc. Design, Automation and Test in Europe, pp. 252-257, 2001 describe power saving techniques in VLIW architecture by suppressing writes to result registers in the write-back stage of the pipeline and employing data forwarding paths to route the operands to the read stage. However, their proposed mechanism requires additional instruction set enhancements using previously unused opcode bits in the instruction set architecture or an increase in the instruction width. These techniques increase the memory access energy.

This invention is applicable to processors having statically scheduled VLIW/EPIC architecture. These processors are suitable for high performance, high clock rate microprocessors as well as embedded processors. This invention neither reduces performance nor changes the instruction set architecture to increase instruction width or use previously unused opcode combinations. In addition, previously compiled code/tools also can be run without modification and without any change in execution behavior.

Scoreboarding processor working registers has been used in processor designs for decades. This technique is used primarily to stall the processor pipeline on data and control dependency conditions. The Intel IA64 EPIC architecture uses scoreboarding of predicate registers to detect hazards (U.S. Pat. No. 6,219,781). This scoreboarding stalls the pipeline until the hazard is cleared. In this invention, scoreboarding of predicate registers is used to save power otherwise consumed in predicated or speculative instructions.

Predication and speculation have been used to enhance performance. No prior attempts to reduce the energy expended in false predication seen in VLIW/EPIC architectures are known. A compiler aware of the invention can exploit it suitably. This compiler will attempt to schedule the predicate-consumer instructions further apart from the predicate-producer instruction. This will maximize the number of times the proposed power saving of this invention occurs.

This invention has the following advantages compared to other known techniques in similar domains:

(1) Power has become a key feature in microprocessor applications, along with the other key features of performance and code size. The inventive power saving technique is applicable to statically scheduled VLIW/EPIC architectures which employ predication. This class of processors have recently gained importance in both workstation and embedded digital signal processor (DSP) applications.

(2) About 6% to 12% of instructions in typical DSP applications can benefit from this invention. As previously noted above, a compiler can be fine tuned to maximize the power saving.

(3) The invention identifies opportunities for saving power dynamically and reduces the energy consumed in predicatively executed instructions that do not commit. The invention is architecture independent and is applicable to all processors employing predication to support speculative execution. The detailed description below uses TMS320C6000 as an example.

(4) The scoreboarding hardware of this invention is a simple and common design technique. Scoreboarding has been traditionally used to stall the processor pipeline. It has not previously been considered for saving power in microprocessors. The hardware cost of implementing the scoreboard bit on predicate registers is very small. In addition, it would be easy for anyone well versed in the art of hardware design to implement this invention.

(5) This hardware solution saves power in predicated instructions that would be wasteful under certain condition. This technique is architecturally transparent because there are no changes to the program execution behavior or to the tools. Hence, programs compiled using a previous generation tool for a previous implementation of the processor will continue to behave as expected. There would be no reduction in performance in this case. The invention would produce power savings.

(6) There exists a loop buffer solution that reduces power in instruction cache accesses. However it is limited to reducing power in loops for instruction accesses. The invention saves power in instruction execution of both loop code (while, for, do) and non-loop code (if-then-else). As the amount of if-then-else type code increases, a compiler could find greater opportunity to predicate such code. Hence the benefit of this invention would increase.

An optimizing compiler in an 8-way VLIW as described above in conjunction with FIGS. 2 and 3 would try to fill as many execution slots as possible with aggressive software pipelining techniques. If-conversion is a known technique that employs predication to reduce the ill-effects of branches. Software pipelining uses predication to move instructions from a loop epilog into the loop kernel. Predication helps prevent the side effect of invalid instruction by nullifying the result of an incorrect execution path.

In a prior art predicated instruction the result register is prevented from updating the destination register if the predicate value is FALSE. The predicate register is read in the E1 phase 331. The result register is committed to the destination register if the predicate value is TRUE. If the predicate value is FALSE, the destination register is not updated. Further, any subsequent pipeline operations for that instruction in pipeline E2 phases 332, E3 phase 333, E4 phase 334 and E5 phase 335 are eliminated.

Due to aggressive instruction scheduling, the optimizing compiler is likely to schedule instructions whose results are not always committed. This results in correct program execution semantics but leads to wasted power. This wasted power occurs in the E1 phase 331 during which the register file is read and the datapath execution goes through at least one stage (E1) of operation. It is profitable to eliminate/reduce the power consumed in this wasted speculative instruction execution.

Below is a code example of loop kernel code for idctsc function in AC3 code for the CPU of FIG. 2. In the instruction semantics [Ax] indicates predication based on the normal value of register Ax and [!Ax] indicates predication based on the inverse register value. Each instruction includes a mnemonic, the identity of the target functional unit, one or two operand registers and the destination register. An “X” in the functional unit designation indicates a cross-register file operand. The loop kernel is shown in execute packets. The symbol “∥” indicates parallel instruction operation.

L9: ; PIPED LOOP PROLOG
;**
L10: ; PIPED LOOP KERNEL
.line 117

EXECUTE PACKET 1

| | | | | | |
|---|---|---|---|---|---|
| | [!A0] | MPY | .M2X | B25,A24,B20 | ; \|167\| <0,13> |
| ∥ | [!A0] | SHR | .S1 | A23,A20,A17 | ; \|168\| <0,13> |
| ∥ | [ A0] | SHL | .S2 | B21,B18,B7 | ; \|173\| <0,13> |
| ∥ | [ B1] | MV | .L1X | B16,A8 | ; \|162\| <0,13> |
| | | | | | ; Define a twin |
| | | | | | ; register |
| ∥ | | MV | .D1 | A9,A24 | ; \|150\| <1,6> |
| | | | | | ; Split a long life |

EXECUTE PACKET 2

| | | | | | |
|---|---|---|---|---|---|
| | [ A1] | BDEC | .S1 | L10,A1 | ; \|186\| <0,14> |
| ∥ | | CMPLT | .L2 B23,0,B0 | ; \|155\| <1,7> | |
| ∥ | | MV | .S2X | A6,B26 | ; \|152\| <1,7> |
| | | | | | ; Define a twin |
| | | | | | ; register |
| ∥ | | MV | .L1X | B26,A20 | ; \|165\| <1,7> |
| | | | | | ; Define a twin |
| | | | | | ; register |
| ∥ | | LDH | .D2T2 | *B4++ (4),B26 | ; \|165\| <2,0> |
| ∥ | | LDH | .D1T1 | *++A4,A9 | ; \|150\| <2,0> |

EXECUTE PACKET 3

| | | | | | |
|---|---|---|---|---|---|
| | [!B1] | SHR | .S1X | B5,A21,A16 | ; \|157\| <0,15> |
| ∥ | [!A0] | SHR | .S2 | B20,B27,B6 | ; \|167\| <0,15> |
| ∥ | | ROTL | .M2 | B0,0,B1 | ; \|155\| <1,8> |
| | | | | | ; Split a long life |
| ∥ | [ B0] | MPY | .M1 | A6,A24,A7 | ; \|162\| <1,8> |
| ∥ | | MV | .L2X | A24,B24 | ; \|150\| <1,8> |
| | | | | | ; Define a twin |
| | | | | | ; register |
| ∥ | | LDH | .D2T2 | *--B17 (4),B23 | ; \|155\| <2,1> |
| ∥ | | LDH | .D1T1 | *--A3 (4),A6 | ; \|152\| <2,1> |

EXECUTE PACKET 4

| | | | | | |
|---|---|---|---|---|---|
| | [ B1] | SHL | .S2X | A18,B16,B9 | ; \|163\| <0,16> |
| ∥ | [ B1] | SHL | .S1 | A7,A8,A16 | ; \|162\| <0,16> |
| ∥ | [ A0] | MV | .L1X | B7,A17 | ; \|173\| <0,16> |
| | | | | | ; Define a twin |
| | | | | | ; register |
| ∥ | [!B0] | MPY | .M2 | B26,B24,B5 | ; \|157\| <1,9> |
| ∥ | [!B0] | MPY | .M1 | A6,A9,A19 | ; \|158\| <1,9> |
| ∥ | | LDH | .D2T2 | *++B8 (4),B25 | ; \|153\| <2,2> |
| ∥ | | LDH | .D1T1 | *++A5,A9 | ; \|151\| <2,2> |

EXECUTE PACKET 6

| | | | | | |
|---|---|---|---|---|---|
| | [ A0] | SHL | .S2X | A22,B18,B6 | ; \|172\| <0,17> |
| ∥ | | SUB | .S1 | A16,A17,A6 | ; \|179\| <0,17> |
| ∥ | | MV | .D1X | B23,A21 | ; \|155\| <1,10> |
| | | | | | ; Define a twin |
| | | | | | ; register |
| ∥ | [ B1] | MPY | .M1 | A6,A9,A18 | ; \|163\| <1,10> |
| ∥ | | CMPLT | .L1 | A20,0,A0 | ; \|165\| <1,10> |
| ∥ | [ B1] | ABS | .L2 | B23,B16 | ; \|162\| <1,10> |

EXECUTE PACKET 7

| | | | | | |
|---|---|---|---|---|---|
| | [!A2] | STW | .D2T1 | A6,*B22 | ; \|179\| <0,18> \hat{ } |
| ∥ | | ADD | .S2 | B9,B6,B24 | ; \|180\| <0,18> |
| ∥ | [!A0] | MPY | .M1X | B25,A9,A23 | ; \|168\| <1,11> |
| ∥ | [ A0] | ABS | .L2 | B27,B18 | ; \|172\| <1,11> |
| ∥ | [ A0] | MPY | .M2X | B25,A9,B21 | ; \|173\| <1, 11> |
| | | .line | 154 | | |

EXECUTE PACKET 8

| | | | | | |
|---|---|---|---|---|---|
| | [ A2] | SUB | .D1 | A2,1,A2 | ; <0,19> |
| ∥ | | ADD | .L2 | 4,B22,B22 | ; \|179\| <0,19> \hat{ } |
| ∥ | [!A2] | STW | .D2T2 | B24, *+B22[B19] | ; \|180\| <0,19> \hat{ } |
| ∥ | [!B1] | SHR | .S2X | A19,B23,B9 | ; \|158\| <1,12> |
| ∥ | [ A0] | MPY | .M1X | B25,A24,A22 | ; \|172\| <1,12> |
| ∥ | | MVD | .M2 | B26,B27 | ; \|165\| <2,5> |
| | | | | | ; Split a long life |

;**
L11: ; PIPED LOOP EPILOG
;** 186 ------------------------------ goto g25;
Note that at several places, both the TRUE and FALSE conditioned instructions are scheduled to be executed. For example, in EXECUTE PACKET 1 the results of instructions SHR and SHL are mutually exclusive. The SHR instruction is predicated by !A0 and the SHL instruction is predicated by A0. The MPY instructions in EXECUTE PACKET 4 are also mutually exclusive by being predicated by opposite senses of the B0 register. The B0 register is set by the instruction
# CMPLT .L2 B23,0,B0 in EXECUTE PACKET 2. The MPY instructions in EXECUTE PACKET 1 and EXECUTE PACKET 8 are mutually exclusive, being predicated by opposite senses of the A0 register. In each of these pairs, only one instruction is committed.

More broadly, out of the 8 MPY instructions in the kernel loop, the results of 3 MPY instructions are never committed in each iteration of the loop. Thus only some of the execution is useful. It is obvious that VLIW data processors employing aggressive scheduling techniques will execute redundant instructions contributing to increased power consumption.

This invention is a mechanism to reduce this redundant power consumption by early detection of predicate register values. This invention detects the value of the predicate register in the DC phase 322. If the predicate is evaluated FALSE, then it is possible to nullify the dependent instruction. However in the example VLIW data processor of FIG. 2, all instructions in a execute packet are dispatched/decoded and processed through E1 phase 331. It is only at the end E1 phase 331 that the result is conditionally committed. Note that the result of any instruction that can change the predicate register is available at the end of its E1 phase 331.

The loop kernel example illustrates the fact that lifetime of the predicate registers may be several cycles. Only the instructions that immediately follow the definition of its predicate register will need to be conditionally committed at the end of E1 phase 331. Any predicated register being used by instructions currently in their DP phase 321 and beyond in the following cycles can be evaluated during DC phase 322. A commonly known technique called scoreboarding enables determination whether there are pending writes to the predicate registers.

FIG. 5 illustrates the scoreboarding hardware needed for each data register that can serve as a predicate register. Instruction decode unit 12 provides a signal whenever it detects a write to the corresponding register. This is termed a predicate register write instruction because the destination register can serve as a predicate register. Note that instruction decode unit 12 provides this signal during the DC phase 322 of the register write instruction. This signal is supplied to the set input of a scoreboard bit 510. The functional unit 500 which is scheduled to write to the corresponding register generates two signals relevant to scoreboarding. The first signal indicates when the write instruction commits data to this register (Commit). This occurs during the E1 phase 331 of the register write instruction. This commit signal supplies one input of OR gate 501. Not shown in FIG. 5 is the actual write path to the destination predicate register. The second signal indicates when the write instruction is nullified (Nullify). The register write instruction can be predicated and can abort due to the state of its predicate register. The nullify signal supplies a second input to OR gate 501. If functional unit 500 generates either signal, then the write to the predicate register is no longer pending. The output of OR gate 501 supplies the reset input of scoreboard bit 510. The Q output of scoreboard bit 510 indicates whether a write is pending to the corresponding predicate register.

FIG. 6 illustrates hardware within each functional unit capable of executing predicated instructions. The hardware illustrated in FIG. 6 determines whether to nullify the results of an instruction dependent upon the state of the predicate register. Register 610 stores the contents of the predicate register Ax designated by the creg field of the current instruction. The identity of the predicate register as well as the operand and destination registers are known during the DC phase 322. The content of the predicate register is recalled from the corresponding register file and stored in register 610 before the beginning of E1 phase 331.

Compare equal to zero unit 621 determines whether the contents of register 610 are zero. Compare equal to zero unit 621 generates a “1” on for zero contents and a “0” otherwise. This compare signal supplies one input to XOR gate 622. The other input of XOR gate 622 receives the z bit (bit 28) of the executing instruction. XOR 622 selects the sense of the predicate register comparison depending on the contents of the z bit.

AND gate 631 makes the early nullification decision. AND gate 631 receives the output of XOR gate 622, the predicate register pending write signal for the designated predicate register on an inverting input and a signal indicating the DC phase 322 for the current instruction. If AND gate 631 detects that the condition of the combination of the creg field and the z bit of the current instruction is not satisfied and no writes are pending to the predicate register during the DC phase 322, then it signals an early nullification. The early nullify signal produces a Nullify Read and Execute signal. This signal will be available early enough in the E1 phase 331 of the current instruction to substantially prevent electrical power use in the functional unit processing the unneeded instruction results. As an example, this early nullification signal may be used to maintain the values on the register file read ports unchanged. This reduces the toggling of the data in the buses carrying the data and in the functional units, thereby reducing the power consumed. AND gate 631 also supplies one input to OR gate 640 which produces a Nullify Results Write signal. This signal prevents the functional unit from writing the results of the instruction into the destination register.

AND gate 633 makes the regular nullification decision (Nullify Results Write). AND gate 633 receives the output of XOR gate 622 and a signal indicating the E1 phase 331 for the current instruction. If AND gate 633 detects that the condition of the combination of the creg field and the z bit of the current instruction is not satisfied during the E1 phase 331, then it signals regular nullification. AND gate 633 supplies one input to OR gate 640 which produces a Nullify Results Write signal. This signal will not be available early enough in the E1 phase 331 of the current instruction to substantially prevent electrical power use in the functional unit processing the unneeded instruction results. However, this regular nullification signal will be early enough to prevent completion of the current instruction by writing its results into the destination register.

Hence, a predicate value available in DC phase 322 can be used to conditionally evaluate the instruction. This permits nullification of that instruction in the DC phase 322, instead of at the end of the E1 phase 331. Note that all instructions must pass through the DC phase 322 to be decoded. Early nullification in the E1 phase 331 enables power saving by preventing the toggling of the register file read buses, the data path in the functional units and by not powering the functional unit of the nullified predicate instruction.

In the above example, the MPY in EXECUTE PACKET 3 cannot be evaluated early since register B0 is being set in EXECUTE PACKET 2 (CMPLT .L2 B23, 0, B0). The two MPY instructions in EXECUTE PACKET 4 can be evaluated early and NOPed if !B0 is false. The MPY instruction in EXECUTE PACKET 1 and EXECUTE PACKET 8 are mutually exclusive. Their predicate register A0 is set in EXECUTE PACKET 6 (CMPLT .L1 A20, 0, A0). In this case, both the MPY instructions can be evaluated early and only one MPY will execute. The unused instruction is removed before execution. The MPY instructions in EXECUTE PACKET 7 are mutually exclusive but one of them can not be nullified early since the predicate register A0 is being set in EXECUTE PACKET 6 (CMPLT .L1 A20, 0, A0).

A compiler that is aware of the early predication mechanism of this invention can exploit it by hoisting the definition of predicate register a cycle earlier. This enables the possibility of early nullification of the dependent instruction to reduce execution power.

This invention is architecturally invisible. The scoreboard registers of this invention do not require any change in the compiler, the current program code base or require any tool modifications.

VLIW data processors such as illustrated in FIG. 2 employ only a small number of predicate registers. In this example only registers A0, A1, A2, B0, B1 and B2 can be predicate registers due to the coding of the creg field. Only these registers are scoreboarded as shown in FIG. 5. Thus only a small amount of additional hardware is needed to practice this invention. This small amount of hardware is not likely to affect processor cycle time because it adds only a single AND gate delay to nullify the instruction in the DC phase.

Typical use of scoreboarding in processors is to eliminate read-after-write hazards and provide sequential semantics by pipeline stalling. The following read instruction in the read-after-write sequence stalls until the write instruction completes operation. This invention is used to reduce execution power only when applicable and is not used to stall execution pipeline. Thus this invention preserves the prior compiler-assumed semantics.

This invention uses the dynamic information not available to the compiler to control instruction execution. A compiler can take advantage of this feature and schedule instructions such that the definition and use of predicate registers are at least 2 cycles (1 cycle predicate latency) apart. This instruction spacing always permits early predicate value determination to achieve maximum power saving.

Analysis of 5 benchmark programs including widely used digital signal processor algorithms (including DSP loops and surrounding control code) indicates the results of from 6% to 12% of all executed instructions are discarded based on a FALSE predicate value. These 6% to 12% of instructions do not contribute to program execution, but consume power. The predicate register scoreboarding of this invention is applicable to both loop kernel code and non-kernel code.

What is claimed is:

1. A pipelined data processor capable of predicated instruction execution dependent upon the state of an instruction designated predicate register comprising:
a data register file including a plurality of read/write, general purpose data registers;
an instruction decode unit operative during an instruction decode pipeline phase receiving fetched instructions and determining the identity of at least one source operand data register, a destination operand data register and one of a plurality of functional units for execution of each instruction, said instruction decode unit further identifying a predicate register responsive to receipt of a predicated instruction;
a plurality of functional units operative during an execution pipeline phase connected to said instruction decode unit for performing a data processing operation on at least one source operand recalled from at least one corresponding instruction designated source data register and producing a result, said functional unit responsive to a predicate instruction to write said result to an instruction designated destination data register if said corresponding predicate data register has a first state and to nullify said instruction and not write said result if said predicate register has a second state opposite to said first state;
a scoreboard bit corresponding to each data register capable of serving as a predicate register, each scoreboard bit connected to said instruction decode unit to be set to a first digital state upon determining said corresponding data register is a destination for an instruction and connected to said plurality of functional units to be reset to a second digital state opposite to said first digital state upon functional unit write of a result to said corresponding data register; and
each functional unit is further operative responsive to a predicate instruction during a decode pipeline phase to nullify said predicate instruction of a following execution phase if said predicate register has said second state and said corresponding scoreboard bit has said second state.

2. The pipelined data processor of claim 1, wherein:
said functional unit is further operative to reset said scoreboard bit to said second digital state upon nullification of said instruction designating a corresponding data register as a destination operand data register.

3. The pipelined data processor of claim 1, wherein:
each functional unit is further operative to operate at a reduced power state for any execution pipeline phase nullified during said preceding instruction decode phase.

4. A method of operating a pipelined data processor capable of predicated instruction execution dependent upon the state of an instruction designated predicate register comprising the steps of:
setting a scoreboard bit to a first digital state upon determining a corresponding data register is a destination for an instruction;
resetting a scoreboard bit to a second digital state opposite to said first digital state upon a write of a result to said corresponding data register;
performing a data processing operation on at least one source operand recalled from at least one corresponding instruction designated source data register and producing a result in response to a predicate instruction designating a corresponding predicate data register and writing said result to an instruction designated destination data register if said corresponding predicate data register has a first state;
nullifying a predicate instruction and not writing said result to the instruction designated destination data register if said corresponding predicate register has a second state opposite to said first state;
nullifying a predicate instruction for a following execution phase if said corresponding predicate register has said second state and said corresponding scoreboard bit has said second state during a prior decode phase.

5. The method of claim 4, further comprising the step of:
resetting a scoreboard bit to a second digital state upon nullification of said instruction designating said corresponding data register as a destination operand data register.

6. The method of claim 4, further comprising the step of:
operating the functional unit at a reduced power state for any execution pipeline phase nullified during said preceding instruction decode phase.

7. The method of claim 4 further comprising the step of:
scheduling a last write to a data register a predetermined number of pipeline phases before an execution phase of a predicate instruction designating said data register as a predicate register.
